(19) United States
(12) Patent Application Publication
(10) Pub. No.: US 2004/0219324 A1
(43) Pub. Date: Nov. 4, 2004

(54) Color compensational layer's structure and manufacturing method

(75) Inventors: Yueh-Hsiang Hsu, TaoYuan (TW); Chien-Shu Lai, TaoYuan (TW); Ta-Wang Lai, TaoYuan (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 10/624,477

(22) Filed: Jul. 23, 2003

(30) Foreign Application Priority Data
May 2, 2003 (TW) 92114977

(51) Int. Cl. B32B 1/00

(52) U.S. Cl. 428/46; 428/142; 428/515

(57) ABSTRACT

A color compensational layer's structure and manufacturing method, wherein the major structure includes: a dye carrier, a first transparent substrate, and a second transparent substrate, and wherein the dye carrier is a plate structure having a first face and a second face, and the dye carrier is particularly inset with dye, and the first transparent substrate and the second transparent substrate are respectively pasted upon the first face and the second face of the dye carrier, and since polarization plate is applied in the color compensational layer, so by the special characteristics of the polarization plate, the dye may first be solved in the water and then be inset into the polarization plate, such that a harmful solvent may be avoided and the cost of dye will be lowered down as well.

### FIELD OF THE INVENTION

The invention relates to a color compensational layer's structure and manufacturing method, and in particular, to a color compensational layer's structure and manufacturing method that apply dye carrier.

### BACKGROUND OF THE INVENTION

Plasma TV mainly comprises a piece of Plasma Display Panel (abbreviated as PDP), which applies inert gases, that is, plasma (e.g., mixture of Neon gas and Xenon gas) that is sealed between two pieces of glass plates. When electronic discharge is created from outside electric field, the ultraviolet rays converted from the energy, of inert gas, created from electronic discharge will excite fluorescent powders, of red, blue, and green colors, coated upon the glass plates to emit light through front glass and visible by human eyes, so these emitted visible lights construct the colorful pictures viewed by the user.

General speaking, in order to make the user watching plasma TV feel natural and comfortable in facing the light emitted from plasma TV and to avoid the radiation of electromagnetic wave, a piece of filter is usually arranged in front of the plasma display panel disposed in the plasma TV.

Basically, this filter is mainly consistent of electromagnetic wave shielding layer (EMI), color compensational layer, anti-reflecting layer (AR), and glass layer, etc. Therefore, after the light emitting from the plasma display panel starts to enter the filter, the light interacts with the electromagnetic wave shielding layer and the color compensational layer, and the electromagnetic wave radiation of the light itself may be removed by the metal mesh structure of the electromagnetic wave shielding layer and, when the light passes through the dye layer of the color compensational layer, the dye will make spectrum calibration to the light, such that the light will be more colorful and three-dimensioned. The glass layer in the filter does not interact with the light and functions as supporting structure to enforce the entire piece of filter. The anti-reflecting layer is designed to protect the user's eyes from being dizzied by the reflection of outside light (ultraviolet rays), which hits the surface of filter facing the user.

So, the user will feel natural and comfortable without the threat of electromagnetic wave radiation, when he is facing the colorful pictures shown by the light that is emitted from the front glass of plasma TV after passing through the filter.

Aiming at the color compensational layer, the inventor proposes the present invention. According to the prior method for manufacturing a color compensational layer, a dye is coated upon the transparent substrate that is made of material of Polyethylene Terephthalate (abbreviated as PET). When light passes through this dye, the dye will make spectrum calibration to the light, such that the light will be more colorful and three-dimensioned.

Please refer to FIG. 1, which shows a color compensational layer structure according to prior arts. This color compensational layer 100 according to prior arts includes transparent substrate 110 and dye 120 coated upon the surface of transparent substrate 110. Those familiar with such arts should know that, since the adhesion ability of the surface of transparent substrate 110 is not very high so, before the dye 120 is coated upon the surface of transparent substrate 110, the dye 120 must be in advance solved in special solvents, for example, the solvent of chloroform. The special solvent solved with dye 120 will be then attached to the surface of the transparent substrate 110 smoothly, such that the dye 120 is coated upon the surface of the transparent substrate 110.

There is one similar structure for prior color compensational layer. Please refer to FIG. 2, which shows another color compensational layer according to prior art. In this color compensational layer 200, the dye 230 is coated between two transparent substrates 210, 220. For manufacturing process, this color compensational layer 200 is substantially same as the color compensational layer 100 shown in FIG. 1. First, the dye 230 is solved in special solvent, and this special solvent solved with dye 230 is coated between the transparent substrates 210, 220.

However, this prior color compensational layer structure has following shortcomings:

1. During the manufacturing process of color compensational layer, the usage of special solvent not only pollutes environment, but also is harmful to human body, such as the solvent of chloroform.

2. The price of dye capable of being solved in special solvent is not cheap and is about several ten thousands per gram.

Accordingly, the invention proposes a color compensational layer's structure and manufacturing method, which apply special solvent that is no harm to human body, and which apply dye of cheaper price as the material of color compensational layer.

### SUMMARY OF THE INVENTION

The main objective of the invention is to provide a color compensational layer structure. This color compensational layer structure is mainly comprised of dye carrier, first transparent substrate, and second transparent substrate. Wherein, the dye carrier is a plate structure having first face and second face and the dye carrier is specially inset with dye. The first transparent substrate and the second transparent substrate are respectively pasted upon the first face and the second face of the dye carrier.

In the preferable embodiment according to the present invention, the transparent substrate may be a layer of Triacetate (TAC) structure or a layer of macromolecule polymer structure.

The secondary objective of the invention is to provide a method for manufacturing color compensational layer structure. This method mainly includes: first, insetting a dye into the dye carrier, then, applying a set of transparent substrate to sandwich this dye carrier inset with dye, such that the dye carrier inset with dye may be extended between these two transparent substrates.

In the preferable embodiment according to the invention, the manufacturing method for this color compensational layer in the step for insetting dye into dye carrier is further comprised of: first, solving the dye into a solvent capable of mixing this dye carrier, then, putting this dye carrier into the solvent solved with dye to extend, such that the dye may be inset into the dye carrier uniformly.

In the preferable embodiment according to the invention, since the dye carrier has special properties, so it may consider water as solvent. Therefore, when the water is chosen as solvent, the choice of dye is multiple, and a dye of cheaper price may be chosen.

In summary, the invention proposes a color compensational layer's structure and manufacturing method, wherein harmful solvent is avoided when manufacturing this color compensational layer, and the cost is lower as well.

### BRIEF DESCRIPTION OF THE DRAWINGS

In order to make your esteemed members of reviewing committee further recognize and understand the characteristics, objectives, and functions of the present invention, a detailed description in accordance with corresponding drawings are presented as follows.

FIG. 1 shows a simple illustration for the color compensational layer according to prior arts.

FIG. 2 shows a simple illustration for another color compensational layer according to prior arts.

FIG. 3 shows a simple illustration for the color compensational layer according to the present invention.

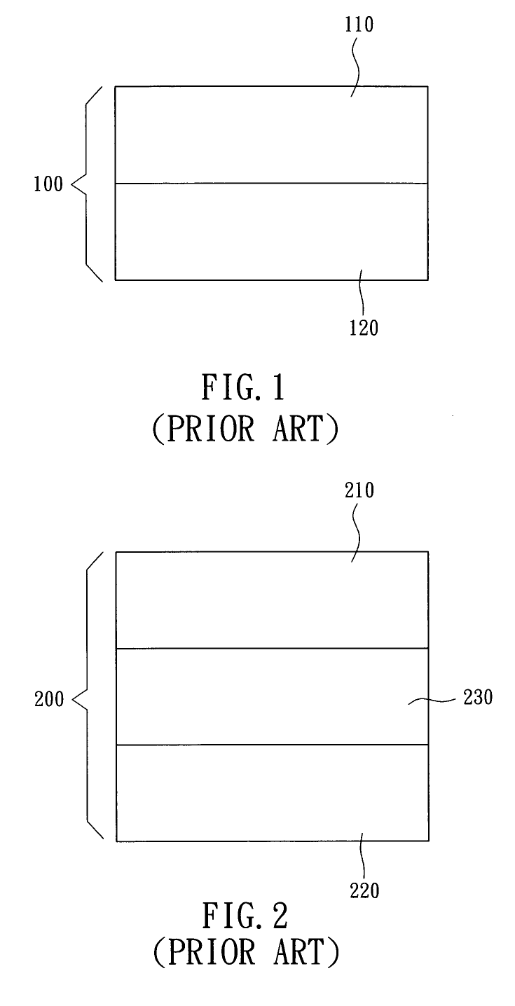

### DETAILED DESCRIPTION OF THE INVENTION

During the process for manufacturing color compensational layer according to prior arts, it is necessary to solve dye into harmful solvent, besides the cost of dye is very high. Therefore, the invention considers applying dye carrier in the color compensational layer by insetting dye into the dye carrier, such that it may avoid the usage of harmful solvent and lower down the cost of dye.

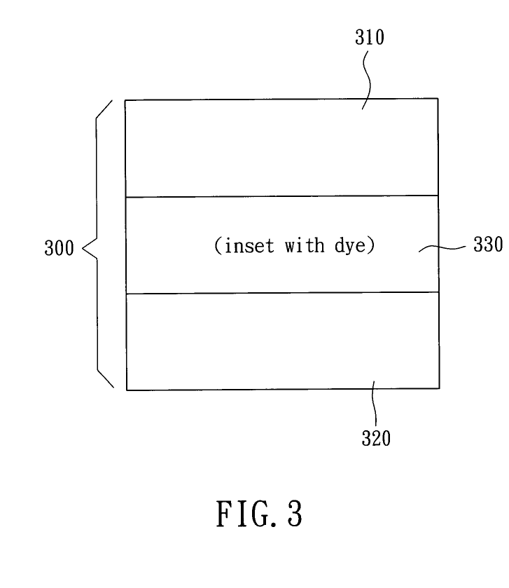

Please refer to FIG. 3, which shows a color compensational layer of the preferable embodiment according to the present invention. This color compensational layer 300 mainly includes: a set of transparent substrate 310, 320 made of materials, such as: Triacetate (TAC), and dye carrier 330 pasted between two transparent substrates. Particularly, in this color compensational layer 300, the dye carrier 330 is inset with dye.

And, in this process for manufacturing color compensational layer 300, except for the dye carrier 330 being inset with dye, if the dye 330 is inset with dye solvable in water, then a harmful solvent may be avoided and the choice of dye is also multiple.

In order to make dye solvable in water be able to inset into dye carrier 330, the choice of dye carrier 330 must consider its chemical activation.

Taking the process for manufacturing polarization plate as example, in order to inset dye into polarization base body to form polarization plate, the polarization base body must choose a transparent plastic having plenty chemical activation, such as: Polyvinyl Alcohol (abbreviated as PVA) of macromolecular polymer.

When taking PVA as elementary material of polarization plate, its manufacturing process is as follows: first, PVA is soaked into water solution of I₂/KI; within few seconds, many iodine ions diffuse into inner layers of PVA; after slightly heating and tensioning by human or mechanical manner, the PVA is elongated to several times and becomes narrow and thin, because the molecules of PVA distribute randomly and irregularly. After tensioning, the molecules of PVA are gradually biased to direction of acting force and the iodine ions adsorbing upon PVA are subsequently oriented to form iodine ions of long chains. Since iodine ions are easily biased, so they may absorb the light component in electric filed parallel to the aligning direction of iodine ions, such that only the light component in electric field of vertical direction passes through. Therefore, applying same principle, a PVA containing iodine ions then becomes the most essential polarization plate.

Therefore, the dye carrier 300 may also apply such PVA material for being inset with dye solvable in water. The process for manufacturing the color compensational layer of the preferable embodiment of the invention may be same as that for manufacturing the Polarization Plate. That is, solving dye in a solvent first, for example, water, which is mixable with the dye carrier 300. Then, the dye carrier 300 is soaked in a water solution containing the dye to make the dye inset into the dye carrier 300. Then, the dye carrier 300 is tensioned in the water solution by manual or mechanical manner, such that the dye may uniformly be inset into the dye carrier 300. Afterwards and finally, the dye carrier 300 is taken out from this water solution and is sandwiched between transparent substrates 310, 320 as shown in FIG. 3.

Since the invention applies dye carrier in color compensational layer, so there are several advantages as follows.

1. During the process for manufacturing color compensational layer according to the invention, wherein the dye is first solved in water before being inset into dye carrier while, according to prior arts, the dye is first solved in harmful solvent before being coated upon the base body of transparent glass, such that the invention may avoid the usage of harmful solvent and be more fulfilled with environmental protection and public safety.

2. Those who are familiar with such arts should know that the cost of the invention is cheaper than that of prior arts, because a dye solvable in water is cheaper than a dye solvable in special solvents.

3. The invention applies a more transparent TAC for being pasted upon two sides of the dye carrier to enforce the color compensational layer, so the transmittance of entire color compensational layer according to the present invention is superior to that of prior arts using PET.

4. The temperature endurance of color compensational layer according to the invention that insets dye into dye carrier is superior to that of prior arts that coat dye upon PET.

One thing is worth mentioning: if the concept of color compensational layer according to the invention is applied, then a dye may just inset into the color compensational layer by using the dye carrier, while the problem of structural enforcement of the color compensational layer in the filter has already been solved by pasting other layers, in the filter, upon two sides of the dye carrier.

In summary, the invention provides a color compensational layer's structure and manufacturing method, wherein a dye carrier inset with dye is applied as the major structure of the color compensational layer; furthermore, transparent substrates made of TAC material are pasted upon two sides of the dye carrier, such that the structure of entire color compensational layer is enforced. Since the invention applies a dye carrier inset with dye as color compensational layer, so the transmittance and temperature endurance of the color compensational layer structure according to the invention become preferable. Additionally, during the process for manufacturing the compensational layer according to the invention, a water applied as solvent is fulfilled with environmental protection and public safety; on the other hand, the usage of dye solvable in water may greatly lower down the cost.

However, aforementioned description is only preferable embodiment according to the present invention and is not any limitation constrained upon the scope of the invention. Any equivalent variation and modification made according to the claims of the invention are still not departed from the merits of the invention, and are also within the spirit and scope of the invention, so they are all regarded as further executable situations of the invention.

What is claimed is:

1. A color compensational layer's structure, which includes:
a first transparent substrate;
a dye carrier, which has a first face and a second face, and which is inset with a dye; and
a second transparent substrate, which is with the first transparent substrate for being pasted respectively upon the first face and the second face of the dye carrier.

2. The color compensational layer's structure according to claim 1, wherein the dye carrier is polyvinyl alcohol (abbreviated as PVA).

3. The color compensational layer's structure according to claim 1, wherein the first transparent substrate is triacetate (abbreviated as TAC).

4. The color compensational layer's structure according to claim 1, wherein the second transparent substrate is triacetate (abbreviated as TAC).

5. The color compensational layer's structure according to claim 1, wherein the second transparent substrate is polyethylene terephthalate (abbreviated as PET).

6. A method for manufacturing color compensational layer comprises the steps of:
insetting a dye into a dye carrier; and
sandwiching the dye carrier with a set of transparent substrate, such that the dye carrier may extend between two transparent substrates.

7. The method for manufacturing color compensational layer according to claim 6, wherein a Polyvinyl Alcohol (abbreviated as PVA) is adapted as the dye carrier.

8. The method for manufacturing color compensational layer according to claim 6, wherein triacetate (abbreviated as TAC) is adapted as the material for said set of transparent substrate.

9. The method for manufacturing color compensational layer according to claim 6, wherein transparent macromolecular polymer is adapted as the material for said set of transparent substrate.

10. The method for manufacturing color compensational layer according to claim 6, wherein one transparent substrate in the set of transparent substrate is made of triacetate (abbreviated as TAC) and another transparent substrate in the set of transparent substrate is made of polyethylene terephthalate (abbreviated as PET).

11. The method for manufacturing color compensational layer according to claim 6, wherein one transparent substrate in the set of transparent substrate is made of triacetate (abbreviated as TAC) and another transparent substrate in the set of transparent substrate is made of transparent macromolecular polymer.

12. The method for manufacturing color compensational layer according to claim 6, wherein the method further includes:
solving the dye into a solvent capable of mixing the dye into the dye carrier; and
soaking the dye carrier in the solvent containing the dye, such that the dye is inset into the dye carrier.

13. The method for manufacturing color compensational layer according to claim 12, wherein the layer is tensioned in the solvent containing the dye by manual manner or mechanical manner, such that the dye is uniformly inset into the dye carrier.

14. The method for manufacturing color compensational layer according to claim 12, wherein a water solution is adapted as the solvent.

15. The method for manufacturing color compensational layer according to claim 12, wherein said set of transparent substrate is made of triacetate (abbreviated as TAC).

16. The method for manufacturing color compensational layer according to claim 6, wherein polyvinyl alcohol (abbreviated as PVA) is coated upon a pasting surface between the dye carrier and said set of transparent substrate.

17. A filter structure comprises a color compensational layer, and said color compensational layer further comprises:
a dye carrier, which is inset with dye.

18. The filter structure according to claim 17, wherein the color compensational layer further includes a set of transparent substrate, which is pasted respectively upon two sides of the dye carrier.

19. The filter structure according to claim 18, wherein said set of transparent substrate is made of triacetate (abbreviated as TAC).
